(19) United States
(12) Patent Application Publication
(10) Pub. No.: US 2019/0111766 A1
(43) Pub. Date: Apr. 18, 2019

(54) Air Vent for a Transport Vehicle

(71) Applicant: Bayerische Motoren Werke Aktiengesellschaft, Muenchen (DE)

(72) Inventors: Florian MIEDL, Muenchen (DE); Stefan FRANCKE, Groebenzell (DE); Thomas TILLE, Muenchen (DE)

(21) Appl. No.: 16/217,264

(22) Filed: Dec. 12, 2018

Related U.S. Application Data
(63) Continuation of application No. PCT/EP2017/064619, filed on Jun. 14, 2017.

(30) Foreign Application Priority Data
Jun. 15, 2016 (DE) 10 2016 210 597.3

(51) Int. Cl. B60H 1/34; B60H 1/00; F24F 13/08

(52) U.S. Cl. CPC B60H 1/3421; B60H 1/00871; B60H 2001/3471; F24F 13/08; B60H 1/00985

(57) ABSTRACT

An air vent for a transport vehicle includes a lamella for directing a first flow of air. The air vent has a flow channel and an actuator. The actuator is designed to modify, in accordance with a control signal, a position of the lamella. The actuator is arranged in the flow channel in such a manner that it is designed to be almost totally surrounded by the first air flow.

### CROSS REFERENCE TO RELATED APPLICATIONS

This application is a continuation of PCT International Application No. PCT/EP2017/064619, filed Jun. 14, 2017, which claims priority under 35 U.S.C. § 119 from German Patent Application No. 10 2016 210 597.3, filed Jun. 15, 2016, the entire disclosures of which are herein expressly incorporated by reference.

### BACKGROUND AND SUMMARY OF THE INVENTION

The present invention relates to a transport vehicle and to an air vent for a transport vehicle for directing an air flow. In particular, the present invention relates to a convenient, user-friendly and precise way of setting the direction of the air flow.

Air vents in transport vehicles serve to direct and in some cases also regulate an air throughput rate of air flows which are generated, for example, by way of an air pump of a heating/air-conditioning system. Lamellas ensure here that the air flow which exits the air vent is directed as desired. In the prior art, said lamellas are frequently oriented by means of tilting/sliding elements. However, these have the disadvantage that a fine setting requires dexterity, in particular while the user is performing a driving task. In particular the adjustment of the elements which are moved relative to one another can be made difficult owing to aging processes and soiling.

DE 10 2007 035 507 A1 discloses a motor vehicle ventilation device in which lamellas which can be adjusted by motor are provided for directing an air flow. Electric pivoting devices are configured to be actuated by a control unit and to pivot, by means of shafts, the lamellas which are arranged in the flow duct.

DE 10 2013 108 655 B3 discloses an air nozzle for passenger compartments in motor vehicles, which air nozzle has pivotable lamellas. The housing has outwardly protruding chambers for accommodating electric motors which permit motor-operated adjustment of the lamellas.

The arrangements which are known from the prior art have in common the fact that actuators are not used in a way which is neutral in terms of installation space.

An object of the present invention is to satisfy the requirement which is known from the prior art.

The object specified above is achieved according to the invention by an air vent for a transport vehicle comprising a lamella for directing a first air flow. The air vent has a flow duct which can also be embodied as the housing of the air vent. The flow duct can have an essentially planar or regular outer surface. In this way, integration into the transport vehicle can be carried out in a way which is optimized in terms of installation space. An actuator is provided within the flow duct, by which actuator a position of the lamella can be changed in response to a control signal. Of course, the direction of an entire package of lamellas comprising a plurality of lamellas which are to be directed essentially in parallel with one another can be influenced by the actuator. According to the invention, the actuator is arranged in the flow duct in such a way that it is configured so as to be almost completely surrounded by the first air flow. In other words, the actuator is arranged in a central region of the flow duct or of the free opening cross section of the flow duct, with the result that a flow duct is produced around the actuator. Of course, webs for securing the actuator to the abovementioned position can be provided.

The arrangement of the actuator has at least two advantages with respect to the prior art: firstly the actuator can be provided in the air vent in a way which is essentially neutral in terms of installation space. On the other hand, there is the possibility of influencing an operating temperature of the actuator by way of the air flow. For example, the actuator can be cooled by the air-conditioning system. Overheating or premature wear of the actuator can be avoided in this way. Moreover, by use of the actuator it is possible to depict influence of the direction of the lamellas in a user-friendly fashion. For example, a direction of the lamellas can be brought about by the actuator using a graphic user interface. Such a change in direction can be carried out, in particular, automatically (e.g. in response to the occurrence of a predefined event and/or to a predefined time being reached). As a result, the user convenience when using the air vent according to the invention is increased compared to the prior art.

The air vent can have, in particular, attachment devices (e.g. latching projections, eyelets, snap-action latching connections) by means of which it is configured to be arranged in a transport vehicle. In particular, openings or air duct outlets can be provided in a dashboard, a door, a pillar trim or the like, of the transport vehicle with the air vent.

Electric, in particular information technology, integration of the air vent into the on-board electrical system of the transport vehicle permits flexible and automatic actuation of the actuator for directing lamellas. For example, a control signal which causes the actuator to direct the lamellas can be received via a bus system. In particular, a plurality of air vents according to the invention can be actuated by means of the same control signal or by means of corresponding control signals. In other words, an air vent assembly can be actuated jointly in response to a predefined user input.

The actuator can be an electric motor (electric rotation machine) and/or a linear drive. Depending on what type of actuator is implemented, a corresponding transmission can be provided in order to influence pivotably coupled lamellas with respect to their direction.

In order to permit the most flexible and accurate direction of the first air flow a first actuator can be provided for directing a first package of lamellas, while a second actuator is provided and configured for adjusting a second package of lamellas.

The first lamella and the second lamella or the first package of lamellas and the second package of lamellas can preferably be arranged essentially perpendicularly with respect to one another and with respect to the main axis of the first air flow. In particular, the pivoting axes of the lamellas can be oriented essentially perpendicularly with respect to the main flow axis of the first air flow.

The air vent can have an activation device which is configured to transmit a control signal to the actuator in response to a predefined activation by a user (user input). The activation device can have a pushbutton, a sliding switch, a touch-sensitive (e.g. capacitive) surface or the like. In particular when a capacitive surface is used, it can be configured in a transparent fashion to permit comfortable reading of a display device which can be arranged behind it.

Such activation devices are frequently arranged in a central region of an outlet of the flow duct. For example, sliding of the activation device can bring about re-direction of the packets of lamellas by motor by means of a user input. In particular, the direction of the sliding can correspond to a change in direction of the first air flow.

An evaluation unit can be provided in the air vent (e.g. in the form of a microcontroller, a nanocontroller or the like and/or in the form of a bus user) which evaluation unit is configured to output, in response to a user input, a control signal to a second actuator of a (second) air vent which is also preferably configured according to the invention. A lamella of the second air vent can be configured in a corresponding way by means of the second control signal. Depending on how the air vents are arranged with respect to one another in relation to the user, the change in direction of the first air flow and of the second air flow (of the second air vent) can take place in parallel with one another or opposed to one another. For example, the user may desire to direct all the air flows onto a part of their body, for which purpose air vents which are arranged in front of him to the left and/or to the right have to execute an opposing change in direction from a parallel initial position. The same applies to the case in which the user does not wish to (or no longer wishes to) have a direct air flow flowing against him.

According to a second aspect of the present invention, a transport vehicle (e.g. a passenger car, a transporter, a truck, an aircraft and/or water craft) is proposed which has one or more air vents according to the first-mentioned aspect of the invention. The features, combinations of features and the advantages arising therefrom correspond to those of the air vent according to the invention so clearly that reference is made to the statements above in order to avoid.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of a driver's workstation with a plurality of air vents according to the prior art.

FIG. 2 is an exploded illustration of an activation device of an exemplary embodiment of an arrangement according to the invention.

FIG. 3 is a perspective view of an exemplary embodiment of an air vent configured according to the invention.

FIG. 4 is a partially sectional perspective illustration of an exemplary embodiment of an arrangement according to the invention.

### DETAILED DESCRIPTION OF THE DRAWINGS

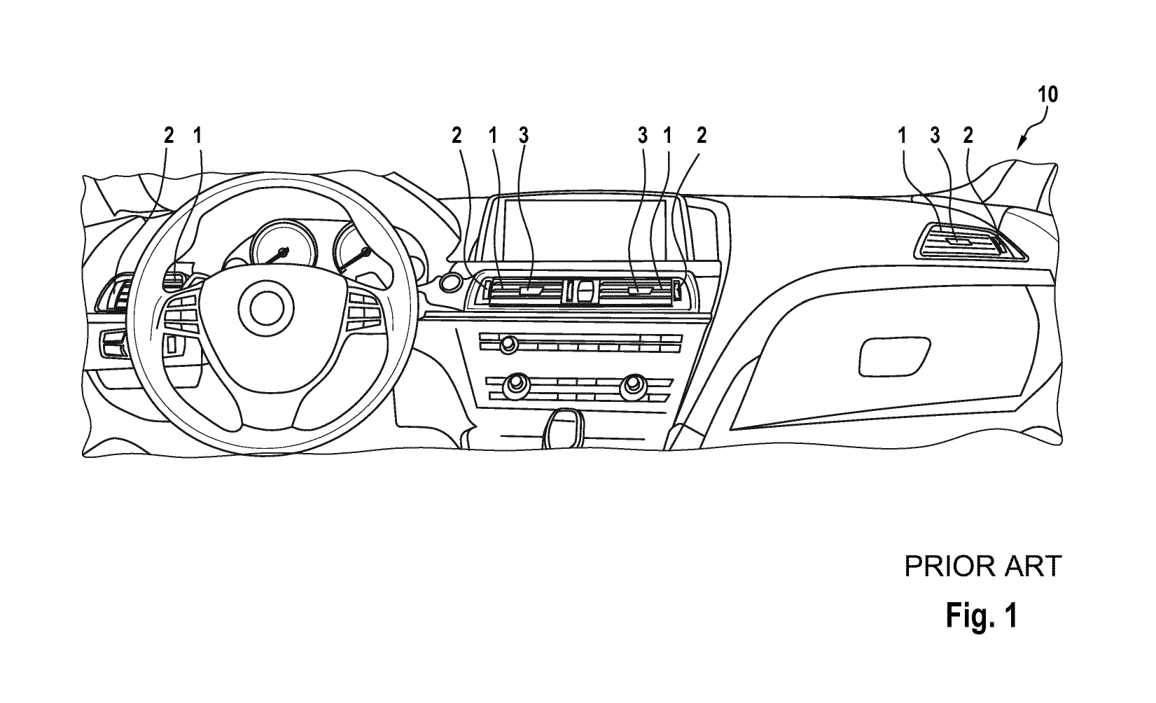

FIG. 1 shows the dashboard/the driver's workstation of a passenger car 10 as a transport vehicle, which dashboard/workstation has four air vents 1 at the height of the user's torso. According to the prior art, tilting/sliding elements 3 for influencing horizontal lamellas and vertical lamellas (not illustrated) are provided approximately at that position at which the arrangement according to the invention is provided. An actuator wheel 2 is assigned to each air vent 1 and can be used to influence a position of the lamellas, by which position the direction of the respective air flow can be influenced. The mechanics of the tilting/sliding regulator 3 can develop an unsuitable frictional force/travel characteristic, in particular as a result of aging processes.

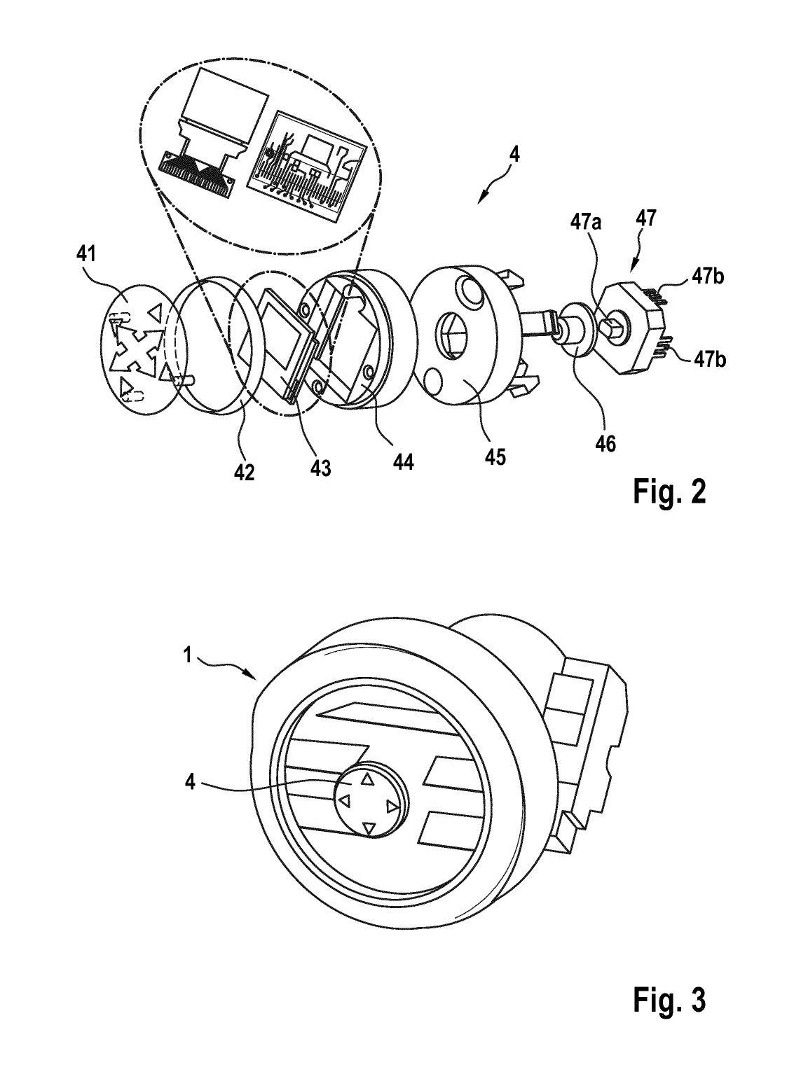

FIG. 2 shows an exploded illustration of an activation device 4 which can be used according to the invention and which has a transparent cover 41 which faces the user and has a touch-sensitive surface. A circular boundary face corresponds to an inner face of a decorative ring 42, via which the user can apply tension/thrust forces to the activation device 4 in a normal fashion with respect to the direction of flow of the air vent. A display device 43 in the form of a small screen/display (referred to as a “wise chip”) is provided behind the cover 41 or the decorative ring 42. The display device 43 corresponds to a cutout which corresponds in turn to a receptacle 44 for the display device 43. The receptacle 44 ensures that the display device 43 is positioned with minimum tolerance and promotes the electrical and information technology connection thereof to the vehicle on-board electrical system and to the touch-sensitive surface of the cover 41. An analog pad housing 45 is arranged behind the receptacle 44, into which analog pad housing an axial securing device 46 can be inserted in such a way that sliding of the analog pad housing 45 entrains the axial securing device 46 in a movement of the receptacle 44 which occurs perpendicularly with respect to the opening face of the air vent, and thus also entrains a pin 47a with respect to the other components of an analog pad 47 as an evaluation unit. The relative movement between the pin 47a and the other component of the analog pad 47 is passed on in the form of an electrical signal via rear-side electrical connections 47b to actuators (not illustrated in FIG. 2) and/or converted into a power actuation of the actuators. The illustrated cover 41 can be fabricated from a two-component material. Its surface can be ground, polished and provided with a clear surface coating. The decorative ring 42 can also have a surface which can be finished by processing, e.g. be metal-coated, ground and polished. The diameter of the receptacle 44 can be in a range between 20 and 50 mm, preferably between 30 and 40 mm. The abovementioned dimensions permit, on the one hand, an easily comprehensible display on the display device 43 and, on the other hand, a sufficiently large free opening cross section between the illustrated activation device and a panel which covers the air vent. The analog pad can resolve, for example, two, four, eight or more different directions of movement of the axial securing device.

FIG. 3 shows a perspective illustration of an air vent 1 with an activation device 4 according to FIG. 2. The activation device 4 is arranged approximately in the center of the flow duct and has four visual marks in the manner of the tip of an arrow. The visual marks surround a display (not illustrated) which in the operating state displays additional information on temperature, flow rate/fan stage and direction of flow as well as a control button for the user to influence the abovementioned properties.

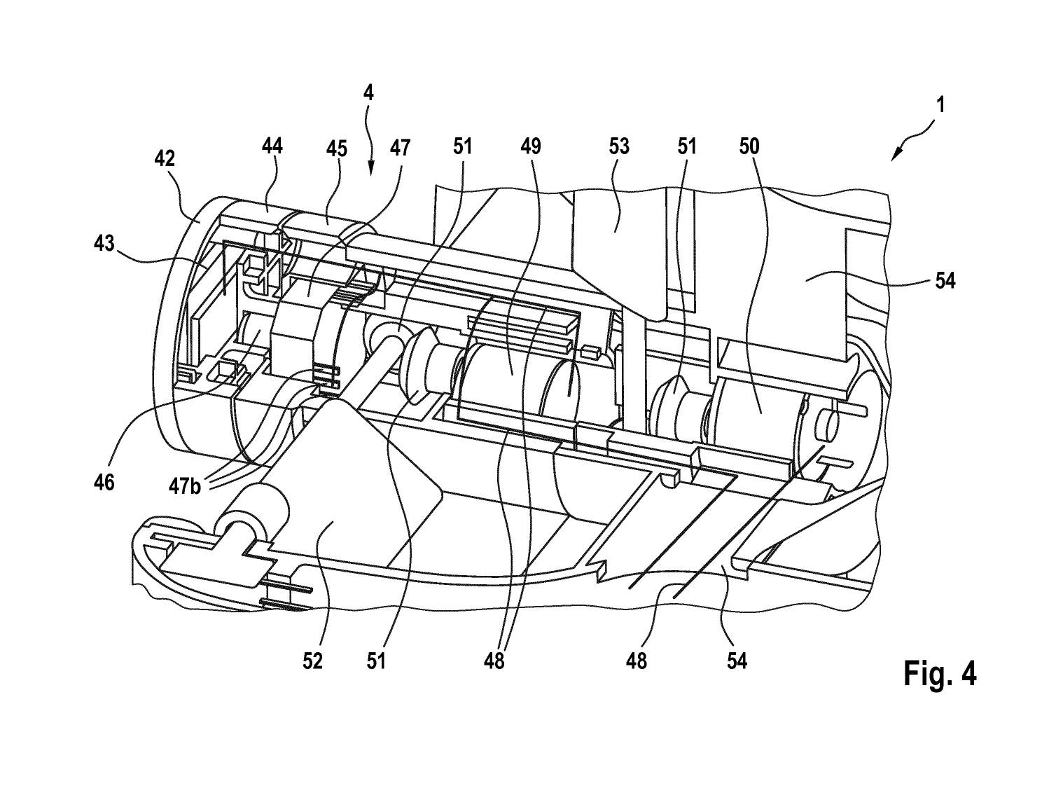

FIG. 4 shows a partially sectional perspective view of the arrangement illustrated in FIG. 3. The elements which are illustrated and discussed in conjunction with FIG. 2 and FIG. 3 have the same reference symbols so that a repeated explanation can be dispensed with. Energy and control lines 48 connect two electric motors 49, 50 as actuators to the electrical connections 47b of the analog pad 47 and the display device 43. The two electric motors 49, 50 are arranged, with respect to their shafts, in parallel with the direction of flow of the fluid surrounding the activation device 4. Bevel gears 51 permit the respectively generated torque to be transferred to lamellas 52, 53 which can be pivoted about a horizontal and/or vertical axis (in each case arranged in a normal fashion with respect to the direction of flow). In this context, the first electric motor 49 is arranged between the lamellas 52 which can pivot about a horizontal axis and the lamellas 53 which can pivot about a vertical axis. The second electric motor 50 is arranged upstream of the lamellas 53 which can pivot about a vertical axis. The two electric motors 49, 50 are arranged coaxially here, that is to say precisely one behind the other in the direction of flow. Fins 54 connect the activation device 4 to structures lying outside the flow duct. The lines 48 are made to extend out of the activation device 4 in the hollow horizontal fin 54. Electrical and information technology (such as signals and data) connection to the vehicle on-board electrical system is not illustrated for the sake of clarity but said connection can also be made (at least proportionally) by means of an information line (such as a bus), with insulation tape wrapped around it, within the flow duct. Since the two electric motors 49, 50 are almost completely surrounded in the circumferential direction by the air flow through the air vent 1, particularly good transfer of heat to the air flow takes place. In this way, the electric motors (in particular during operation of an air-conditioning function) can be cooled efficiently.

### LIST OF REFERENCE NUMBERS

1 Air vent
2 Actuator wheel
3 Tilting/sliding elements
4 Activation device
10 Passenger car
41 Cover
42 Decorative ring
43 Display device
44 Mounting device
45 Analog pad housing
46 Axial securing device
47 Analog pad
47a Pin
47b Electrical connections
48 Lines
49, 50 Electric motor/actuator
51 Bevel gear
52, 53 Lamellas
54 Fins

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An air vent for a transport vehicle, comprising:
a lamella for directing a first air flow;
a flow duct; and
an actuator,
wherein
the actuator is configured to change a position of the lamella in response to a control signal, and
the actuator is arranged in the flow duct such that the actuator is configured so as to be almost completely surrounded by the first air flow.

2. The air vent as claimed in claim 1, wherein
the air vent is configured to be arranged in the transport vehicle.

3. The air vent as claimed in claim 2, wherein
the air vent is configured to be integrated into an on-board electrical system of the transport vehicle, by which electrical system the control signal is obtained.

4. The air vent as claimed in claim 1, wherein
the actuator comprises:
an electric motor, and/or
a linear drive.

5. The air vent as claimed in claim 1, further comprising:
a second lamella; and
a second actuator provided and configured to adjust the second lamella.

6. The air vent as claimed in claim 5, wherein
the second lamella is arranged essentially perpendicularly with respect to the first lamella.

7. The air vent as claimed in claim 6, wherein
the first and second lamella pivot about respective axes which are oriented essentially perpendicularly with respect to the direction of flow.

8. The air vent as claimed in claim 1, further comprising:
an activation device, wherein
the activation device is configured to transmit a control signal to the actuator in response to a predefined activation by a user, and has a touch-sensitive surface which is arranged on a display device.

9. The air vent as claimed in claim 8, wherein
the display device is configured to be moved together with the activation device by an activation by the user.

10. The air vent as claimed in claim 1, further comprising:
an evaluation unit, wherein
the evaluation unit is configured to actuate, in response to a user input, an actuator of a second air vent in order to actuate a lamella of the second air vent such that a second air flow which flows through the second air vent:
(i) is directed onto a point onto which the first air flow is also directed,
(ii) experiences an identical change in direction, or
(iii) experiences an opposing change in direction.

11. A transport vehicle, comprising an air vent as claimed in claim 1.
